(19) United States
(12) Patent Application Publication
(10) Pub. No.: US 2005/0257230 A1
(43) Pub. Date: Nov. 17, 2005

(54) Disk tray for a disk drive

(75) Inventors: Chun-Ting Wu, Hsinchu-City (TW); Ui-Wei Tu, Hsinchu-City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/025,909

(22) Filed: Jan. 3, 2005

(30) Foreign Application Priority Data
May 11, 2004 (TW) 93113163

(51) Int. Cl. G11B 17/04; G11B 17/03; G11B 33/02

(52) U.S. Cl. 720/603

(57) ABSTRACT

A tray body has a disk-receiving space defined by a disk-confining wall having a bottom wall surface confining a bottom side of the disk-receiving space and a peripheral wall surface converging gradually and outwardly from the bottom wall surface thereof. The bottom wall surface of the disk-receiving space has a central portion indented to form an inner disk-receiving space and an outer disk-receiving space around the inner disk-receiving space. A recess-confining wall has a bottom wall surface confining a bottom side of the inner disk-receiving space and a peripheral wall surface converging gradually and outwardly from the bottom wall surface. The tray body is formed with a reading hole extending through portions of the bottom surfaces of the recesses adjacent to the rear end.

### FIELD OF THE INVENTION

The invention relates to a disk drive, more particularly to a disk drive provided with a retractable-and-extendible disk tray having a structure which can prevent from causing damage to an optical disk during placing and removing the optical disk onto and from the disk tray.

### BACKGROUND OF THE INVENTION

To protect the recorded surface of an optical disk from being scratched, the optical disk is generally kept in protective sleeve when it is not in use. Nevertheless, the recorded surface of the optical disk can still be accidentally scratched due to the lack of proper care. For example, most of the damage caused to the optical disk happens during placing and removing of the same onto and from a disk tray of an optical instrument, such as DVD or CD players.

FIG. 1 shows a perspective view of a conventional disk tray 10 generally employed in a disk drive, such as a DVD player, and has an upper surface 102 formed with a disk-receiving space including an inner disk-receiving space 108 and an outer disk-receiving space 106 surrounding the inner disk-receiving space 106, and a reading opening 104 extending from a rear end toward a front end thereof. The reading opening 104 extends through portions of the bottom surfaces of the inner and outer disk-receiving spaces 106, 108 proximate to the rear end of the conventional disk tray 10. The conventional disk tray 10 is capable of receiving a small-diameter disk 24 in the inner disk-receiving space 108 and a large-diameter disk 22 in the outer disk-receiving space 106.

One disadvantage that results from the use of the aforesaid conventional disk tray 10 is that the optical disk 22, 24 may be accidentally scratched by those sharp ridges 112, 114 formed at adjoining positions of the inner and outer disk-receiving spaces 108, 106 and the reading opening 104 during the placing or removing operation of the optical disk 22,24 onto and from the conventional disk tray 10.

### SUMMARY OF THE INVENTION

The object of the present invention is to provide a disk tray for use in a disk drive. The disk tray has a structure which can prevent the recorded surface of the optical disk from being scratched, thereby eliminating the aforesaid disadvantage resulting from the use of the conventional disk tray.

In one aspect of the present invention, a disk drive is provided to include a disk tray. The disk tray includes: a tray body having front and rear ends, and a disk-receiving space between the front and rear ends and adapted to receive a disk therein, the disk-receiving space being defined by a disk-confining wall that has a bottom wall surface confining a bottom side of the disk-receiving space and a peripheral wall surface extending upwardly from the bottom wall surface, the tray body being formed with a reading hole that is formed through a portion of the bottom wall surface of the disk-receiving space adjacent to the rear end and that extends from the rear end toward the front end, the tray body further being formed with a gripping depression that is formed in the bottom wall surface of the disk-receiving space and that is disposed at a periphery of the disk-receiving space.

In anther aspect of the present invention, a disk drive is provided to include a disk tray. The disk tray includes: a tray body having front and rear ends, and a disk-receiving space between the front and rear ends, the disk-receiving space being defined by a disk-confining wall that has a bottom wall surface confining a bottom side of the disk-receiving space and a peripheral wall surface converging gradually and outwardly from the bottom wall surface, the bottom wall surface of the disk-receiving space having a central portion indented to form an inner disk-receiving space such that an outer disk-receiving space is formed around the inner disk-receiving space, the inner disk-receiving space being defined by a recess-confining wall having a bottom wall surface confining a bottom side of the inner disk-receiving space and a peripheral wall surface converging gradually and outwardly from the bottom wall surface of the inner disk-receiving space, the tray body further being formed with a reading hole that is formed through portions of the bottom wall surfaces of the outer and inner disk-receiving spaces adjacent to the rear end and that extends from the rear end toward the front end, the tray body further being formed with a gripping depression that is formed in the bottom wall surface of the outer disk-receiving space and that is disposed at a periphery of the inner disk-receiving space.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional disk tray that is generally employed in a disk drive;

FIG. 2 is a perspective view of the first embodiment of a disk tray according to the present invention for use in a disk drive;

FIG. 2A is an enlarged view of a first encircled portion of the first embodiment shown in FIG. 2;

FIG. 2B is an enlarged view of a second encircled portion of the first embodiment shown in FIG. 2;

FIG. 3 is a perspective view of the second embodiment of a disk tray according to the present invention for use in a disk drive;

FIG. 3A is an enlarged view of a first encircled portion of the second embodiment shown in FIG. 3; and

FIG. 3B is an enlarged view of a second encircled portion of the second embodiment shown in FIG. 3.

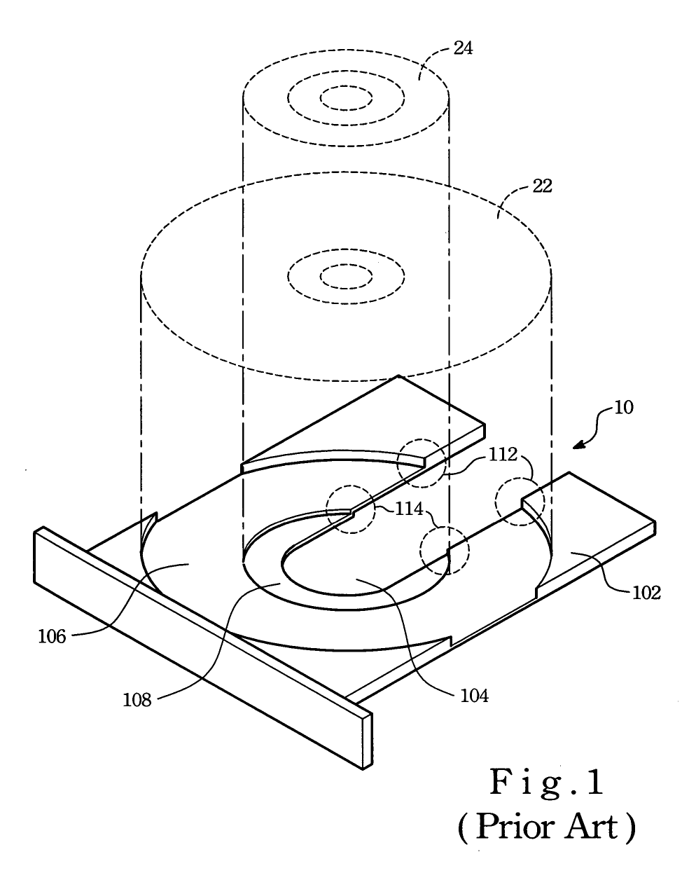

### DETAILED DESCRIPTIONS OF THE PREFERRED EMBODIMENTS

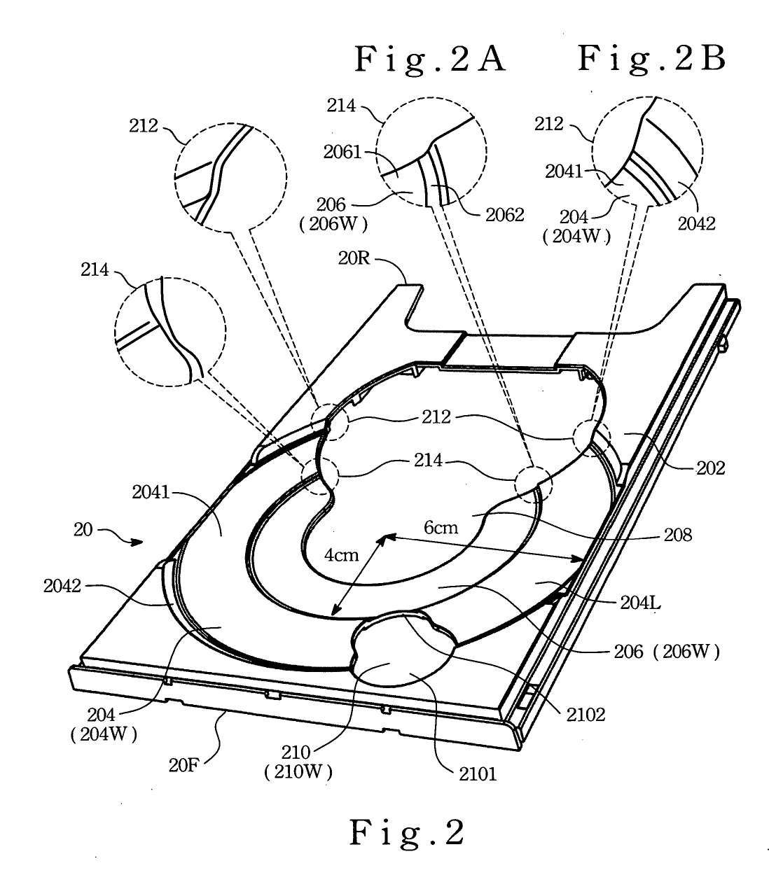

Referring to FIG. 2, a perspective view of the first embodiment of a disk tray according to the present invention is used in an optical disk drive, such as a DVD player, including a tray body 20 for receiving a small-diameter disk 24 and a large-diameter disk 22. According to the CD specification, the large-diameter disk 22 has a diameter of 12 cm, and the small-diameter disk 24 has a diameter of 8 cm. The tray body 20 is further provided with two opposite rails for conveying the same into the disk drive.

As illustrated, the tray body 20 has opposite front and rear ends 20F, 20R, and a disk-receiving space 204 between the front and rear ends 20F, 20R. The disk-receiving space 204 is defined by a disk-confining wall 204W that has a bottom wall surface 2041 (see FIG. 2B) confining a bottom side of the disk-receiving space 204 and a peripheral wall surface 2042 converging gradually and outwardly from the bottom wall surface 2041. The bottom wall surface 2041 of the disk-receiving space 204 has a central portion indented to form an inner disk-receiving space 206 such that an outer disk-receiving space 204L is formed around the inner disk-receiving space 206.

FIG. 2A is an enlarged view of the encircled potion 214 of FIG. 2. As shown, the inner disk-receiving space 206 is defined by a recess-confining wall 206W that has a bottom wall surface 2061 confining a bottom side of the inner disk-receiving space 206 and a peripheral wall surface 2062 converging gradually and outwardly from the bottom wall surface 2061 of the inner disk-receiving space 206. The tray body 20 is formed with an 8-shaped reading hole 208 (see FIG. 2) that is formed through portions of the bottom surfaces of the outer and inner disk-receiving spaces 204L, 206 adjacent to the rear end 20R and that extends from the rear end 20R toward the front end 20F.

Referring to FIG. 2 again, the tray body 20 is further formed with a gripping depression 210 that is formed in the bottom wall surface of the outer disk-receiving space 204L and that is disposed at a periphery of the inner disk-receiving space 206. The gripping depression 210 is preferably defined by a depression-confining wall 210W having a bottom wall surface 2101 that confines a bottom side of the gripping depression 210 and that is disposed at an elevation lower than the bottom wall surfaces of the inner and outer disk-receiving spaces 204L, 206. In the first embodiment, the gripping depression 210 can be a through hole defined by a hole-confining wall 210W extending through a portion the bottom wall surface of the outer disk-receiving space 204L adjacent to the front end 20F of the tray body 20. When the tray body 20 is thus arranged, the inner disk-receiving space 206 is adapted to receive a small-diameter optical disk (for example, with 8 cm in diameter, not shown in FIG. 2) while the outer disk-receiving space 204L is adapted to receive a large-diameter optical disk (for example, with 12 cm in diameter, not shown in FIG. 2). When it is desired to remove the disk from the tray body 20, especially for a 8 cm disk, the user can insert his fingers into the reading hole 208 or the central hole of the disk while the thumb thereof can be inserted into the gripping depression 210, thereby securely clamping inner and outer peripheries of the disk so as to prevent the disk from being scratched or falling off the user's hand.

An important aspect to note that the disk tray 20 is generally made from plastics by molding or extrusion methods. After production and in case some sharp ridge is found during the inspection process, the former should be ground to provide smooth converging of the peripheral wall surfaces 2062, 2042 of the inner and outer disk-receiving spaces 206, 204L so as to avoid damage caused by scratching during placing and removing of the disk onto and from the tray body 20 of the present invention.

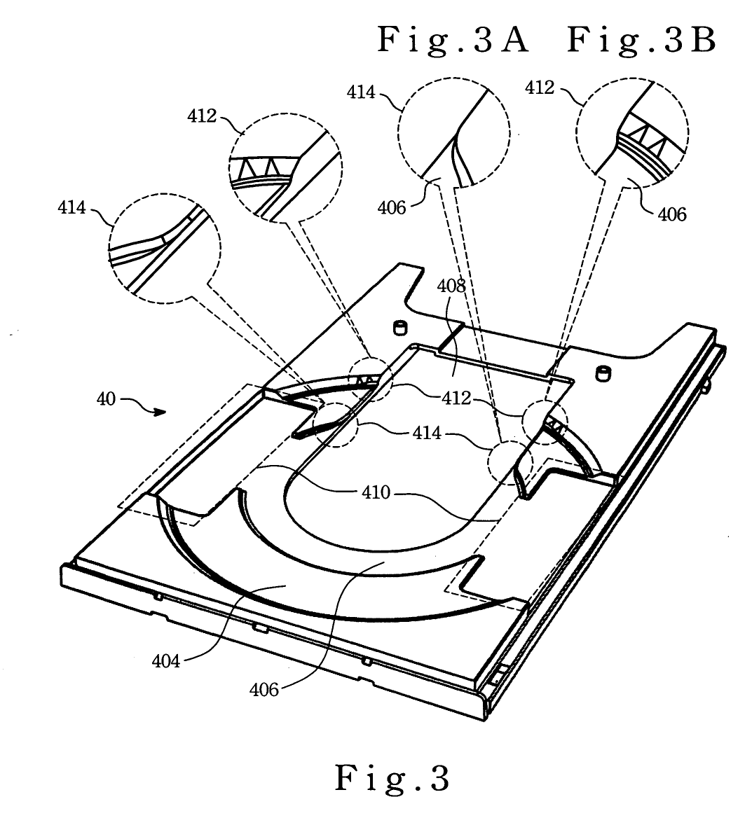

Referring to FIG. 3, the second embodiment of a disk tray 40 according to the present invention is show to have the construction similar to the previous embodiment. The main difference resides in that the gripping depression includes left and right depression portions 410 disposed at left and right sides of the inner and outer disk-receiving spaces 406, 404. FIGS. 3A and 3B respectively show enlarged view of the encircled portions 412, 414 of FIG. 3. The adjacent positions of the inner and outer disk-receiving spaces 406, 404 and the reading opening 408 are similarly treated in order to prevent damage caused to the disk during placing and removing operation.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A disk drive includes a disk tray, the disk tray comprising:
a tray body having front and rear ends, and a disk-receiving space between said front and rear ends and adapted to receive a disk therein, said disk-receiving space being defined by a disk-confining wall that has a bottom wall surface confining a bottom side of said disk-receiving space and a peripheral wall surface extending upwardly from said bottom wall surface, said tray body being formed with a reading hole that is formed through a portion of said bottom wall surface of said disk-receiving space adjacent to said rear end and that extends from said rear end toward said front end, said tray body further being formed with a gripping depression that is formed in said bottom surface of said disk-receiving space and that is disposed at a periphery of said disk-receiving space.

2. The disk drive according to claim 1, wherein said gripping depression is defined by a depression-confining wall having a bottom wall surface that confines a bottom side of said gripping depression and that is disposed at an elevation lower than said bottom wall surface of said disk-receiving space.

3. The disk drive according to claim 1, wherein said peripheral wall surface of said disk-receiving space converges gradually and outwardly from said bottom wall surface.

4. The disk drive according to claim 1, wherein said bottom surface of said disk-receiving space has a central portion indented to form an inner disk-receiving space such that an outer disk-receiving space is formed around said inner disk-receiving space, said inner disk-receiving space being defined by a recess-confining wall having a bottom wall surface confining a bottom side of said inner disk-receiving space and a peripheral wall surface extending upwardly from said bottom wall surface of said inner disk-receiving space, said bottom wall surface of said inner disk-receiving space being disposed at an elevation higher than said bottom wall surface of said gripping depression, said reading hole extending through a portion of said bottom wall surface of said inner disk-receiving space adjacent to said rear end of said tray body.

5. The disk drive according to claim 3, wherein said peripheral wall surface of said inner disk-receiving space converges gradually and outwardly from said bottom wall surface of said inner disk-receiving space, said gripping depression being disposed at a periphery of said inner disk-receiving space.

6. The disk drive according to claim 1, wherein said gripping depression includes left and right depression portions disposed at left and right sides of said outer disk-receiving space.

7. The disk drive according to claim 1, wherein said gripping depression is a through hole defined by a hole-confining wall extending through a portion said bottom surface of said disk-receiving space adjacent to said front end of said tray body.

8. A disk drive includes a disk tray, the disk tray comprising:
a tray body having front and rear ends, and a disk-receiving space between said front and rear ends and adapted to receive a disk therein, said disk-receiving space being defined by a disk-confining wall that has a bottom wall surface confining a bottom side of said disk-receiving space and a peripheral wall surface converging gradually and outwardly from said bottom wall surface, said tray body being formed with a reading hole that is formed through a portion of said bottom wall surface of said disk-receiving space adjacent to said rear end and that extends from said rear end toward said front end.

9. The disk drive according to claim 8, wherein said tray body is further formed with a gripping depression that is formed in said bottom wall surface of said disk-receiving space and that is disposed at a periphery of said disk-receiving space.

10. The disk drive according to claim 9, wherein said gripping depression is defined by a depression-confining wall having a bottom wall surface that confines a bottom side of said gripping depression and that is disposed at an elevation lower than said bottom wall surface of said disk-receiving space.

11. The disk drive according to claim 8, wherein said bottom surface of said disk-receiving space has a central portion indented to form an inner disk-receiving space such that an outer disk-receiving space is formed around said inner disk-receiving space, said inner disk-receiving space being defined by a recess-confining wall having a bottom wall surface confining a bottom side of said inner disk-receiving space and a peripheral wall surface converging gradually and outwardly from said bottom wall surface of said inner disk-receiving space, said bottom surface of said inner disk-receiving space being disposed at an elevation higher than said bottom wall surface of said gripping depression, said reading hole extending through a portion of said bottom wall surface of said inner disk-receiving space adjacent to said rear end of said tray body.

12. The disk drive according to claim 11, wherein said gripping depression is disposed at a periphery of said inner disk-receiving space.

13. The disk drive according to claim 11, wherein said gripping depression includes left and right depression portions disposed at left and right sides of said outer disk-receiving space.

14. The disk drive according to claim 9, wherein said gripping depression is a through hole defined by a hole-confining wall extending through a portion said bottom surface of said disk-receiving space adjacent to said front end of said tray body.

15. A disk drive includes a disk tray, the disk tray comprising:
a tray body having front and rear ends, and a disk-receiving space between said front and rear ends, said disk-receiving space being defined by a disk-confining wall that has a bottom wall surface confining a bottom side of said disk-receiving space and a peripheral wall surface converging gradually and outwardly from said bottom wall surface, said bottom wall surface of said disk-receiving space having a central portion indented to form an inner disk-receiving space such that an outer disk-receiving space is formed around said inner disk-receiving space, said inner disk-receiving space being defined by a recess-confining wall having a bottom wall surface confining a bottom side of said inner disk-receiving space and a peripheral wall surface converging gradually and outwardly from said bottom wall surface of said inner disk-receiving space, said tray body being formed with a reading hole that is formed through portions of said bottom wall surfaces of said outer and inner disk-receiving spaces adjacent to said rear end and that extends from said rear end toward said front end, said tray body further being formed with a gripping depression that is formed in said bottom wall surface of said outer disk-receiving space and that is disposed at a periphery of said inner disk-receiving space.

16. The disk drive according to claim 15, wherein said gripping depression is defined by a depression-confining wall having a bottom wall surface that confines a bottom side of said gripping depression and that is disposed at an elevation lower than said bottom wall surfaces of said inner and outer disk-receiving spaces.

17. The disk drive according to claim 15, wherein said gripping depression includes left and right depression portions disposed at left and right sides of said outer disk-receiving space.

18. The disk drive according to claim 15, wherein said gripping depression is a through hole defined by a hole-confining wall extending through a portion said bottom wall surface of said outer disk-receiving space adjacent to said front end of said tray body.
